(19) United States
(12) Patent Application Publication
(10) Pub. No.: US 2026/0131799 A1
(43) Pub. Date: May 14, 2026

(54) MULTI-DEVICE MONITORING OF WHEEL SPEED SENSOR OUTPUT

(71) Applicant: Rivian IP Holdings, LLC, Irvine, CA (US)

(72) Inventors: Joseph Daniel HIMMELHEBER, Redondo Beach, CA (US); Michael James HIBBARD, Long Beach, CA (US); Vivek VAID, Ladera Ranch, CA (US)

(21) Appl. No.: 19/357,848

(22) Filed: Oct. 14, 2025

Related U.S. Application Data
(60) Provisional application No. 63/719,064, filed on Nov. 11, 2024.

(51) Int. Cl. B60W 50/02

(52) U.S. Cl. CPC B60W 50/0205; B60W 2050/0215; B60W 2420/20; B60W 2520/28; B60W 2756/00

(57) ABSTRACT

The present disclosure relates to a processing system for a vehicle, and more particularly, techniques for wheel speed sensing with increased reliability. One example apparatus for wheel speed signal processing generally includes: a first controller configured to receive a wheel speed signal and process the wheel speed signal to identify a first wheel speed for a wheel of a vehicle; and a second controller configured to receive the wheel speed signal and process the wheel speed signal to identify a second wheel speed for the wheel of the vehicle, wherein the first wheel speed is compared to the second wheel speed to identify an error associated with the wheel speed signal processing.

### CROSS-REFERENCE TO RELATED APPLICATION

This application claims benefit of and priority to U.S. Provisional Application No. 63/719,064 filed November 11, 2024, which is hereby expressly incorporated by reference herein in its entirety as if fully set forth below and for all applicable purposes.

### FIELD OF THE DISCLOSURE

The present disclosure relates to a processing system for a vehicle, and more particularly, techniques for wheel speed sensing with increased reliability.

### DESCRIPTION OF RELATED ART

Vehicles may be equipped with various control systems designed to enhance their functionality, safety, and efficiency. These systems manage and regulate different vehicle components to achieve specific performance outcomes. At the core of these systems are feedback loops, sensors, actuators, and control algorithms that monitor and adjust various parameters. For instance, a vehicle may include multiple exterior cameras to capture views around the vehicle, which are then displayed to the driver on front displays. Control systems in vehicles also play an important role in detecting the speed of the vehicle. This is often achieved through wheel speed sensors. These sensors generate signals that are processed by electronic control units (ECUs) to derive the wheel speed. Accurate measurement of wheel speed is important for ensuring the safe and efficient operation of modern vehicles. Reliable wheel speed data underpins important systems such as anti-lock braking, traction control, and stability management, directly impacting vehicle responsiveness and occupant safety. Discrepancies in wheel speed sensing can lead to performance degradation, increased wear on mechanical components, and compromised safety features.

### SUMMARY

Certain aspects of the present disclosure are directed towards an apparatus for wheel speed signal processing. The apparatus generally includes: a first controller configured to receive a wheel speed signal and process the wheel speed signal to identify a first wheel speed for a wheel of a vehicle; and a second controller configured to receive the wheel speed signal and process the wheel speed signal to identify a second wheel speed for the wheel of the vehicle, wherein the first wheel speed is compared to the second wheel speed to identify an error associated with the wheel speed signal processing.

Certain aspects of the present disclosure are directed towards a method for wheel speed signal processing. The method generally includes: processing, via a first controller, a wheel speed signal to identify a first wheel speed for a wheel of a vehicle; and processing, via a second controller, the wheel speed signal to identify a second wheel speed for the wheel of the vehicle, wherein the first wheel speed is compared to the second wheel speed to identify an error associated with the wheel speed signal processing.

Certain aspects of the present disclosure are directed towards a vehicle. The vehicle generally includes: a wheel; a wheel speed sensor configured to generate a wheel speed signal for the wheel; a first controller configured to receive the wheel speed signal and process the wheel speed signal to identify a first wheel speed for the wheel; and a second controller configured to receive the wheel speed signal and process the wheel speed signal to identify a second wheel speed for the wheel of the vehicle, wherein the first wheel speed is compared to the second wheel speed to identify an error associated with the wheel speed signal processing.

### BRIEF DESCRIPTION OF THE DRAWINGS

FIG. 1A illustrates an example vehicle in accordance with certain embodiments.

FIG. 1B illustrates a chassis of a vehicle in accordance with certain embodiments.

FIG. 2A is a schematic block diagram of components of a vehicle in accordance with certain embodiments.

FIG. 2B is a schematic block diagram of alternative components of a vehicle in accordance with certain embodiments.

FIG. 3 illustrates a processing system with multiple electronic control units (ECUs) where each of multiple wheel sensor signals is consumed by the multiple ECUs, in accordance with certain aspects of the present disclosure.

FIG. 4 illustrates an example current sensing system for identifying wheel speed at each of multiple ECUs, in accordance with certain aspects of the present disclosure.

FIG. 5 is a flow diagram illustrating example operations for wheel speed signal processing, in accordance with certain aspects of the present disclosure.

### DETAILED DESCRIPTION

Certain aspects of the present disclosure are directed towards apparatus and techniques for wheel speed signal processing. A wheel speed sensor may be used to generate a wheel speed signal for a wheel of a vehicle. The wheel speed signal may be received and processed by separate controllers to identify the wheel speed independently. For example, a first controller may process the wheel speed signal to identify a first wheel speed, while a second controller processes the same signal to identify a second wheel speed. The two derived wheel speeds are then compared to identify any errors associated with the wheel speed signal processing. This redundant processing increases the accuracy and reliability of the wheel speed data, which is important for the safe and efficient operation of vehicles. In some cases, separate power domains may be used for the separate controllers. In this manner, if one power domain for one controller experiences an error causing one controller to stop monitoring wheel speed, another controller can continue wheel speed monitoring.

By utilizing redundant processing through multiple controllers, the system can identify and mitigate errors that may arise during signal processing. This leads to improved performance of important vehicle systems such as anti-lock braking, traction control, and stability management. Additionally, the use of separate power domains for the controllers allows power supply-related errors to not impact the entire wheel speed monitoring system, further enhancing the robustness of the wheel speed sensing mechanism.

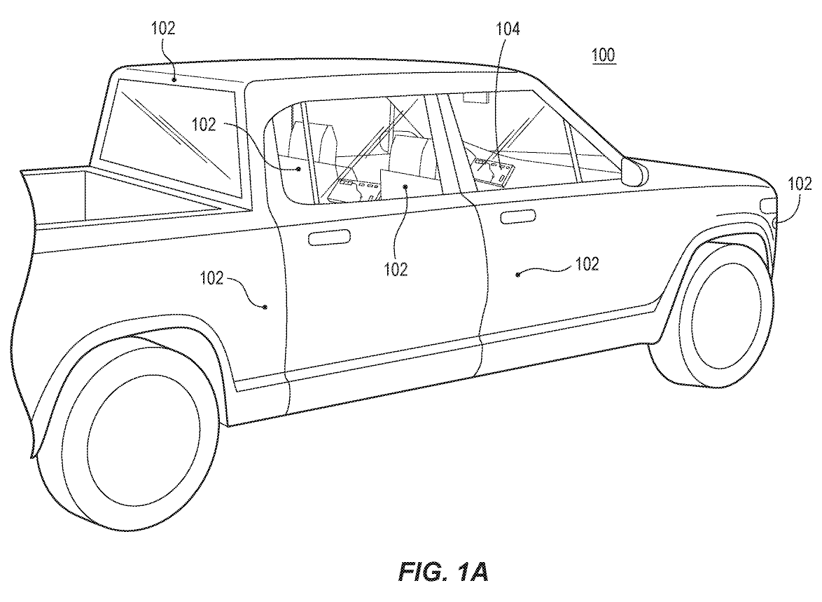

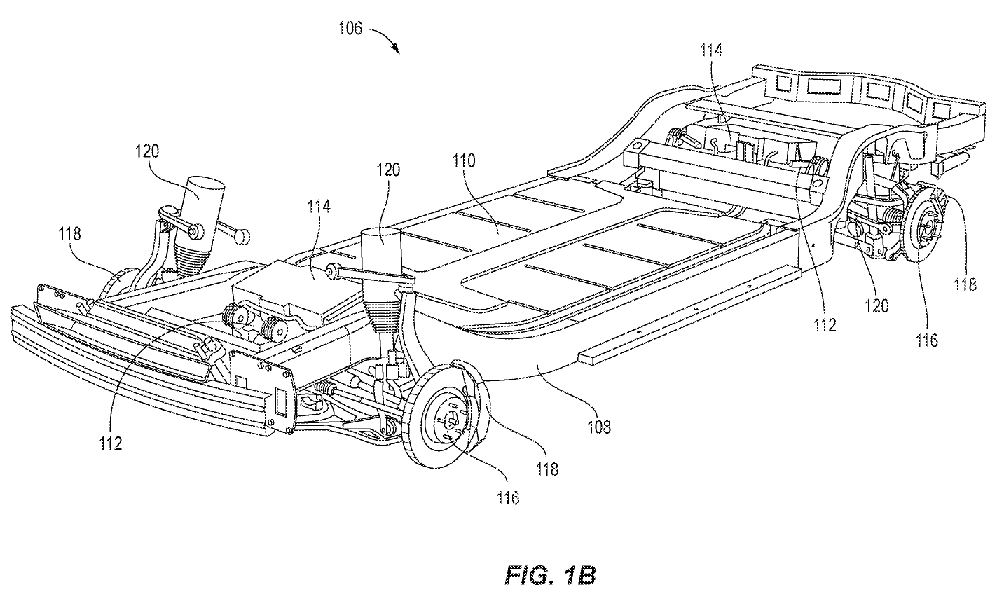

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear reduction drive. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power electronics 114. The power electronics 114 may include inverters configured to convert direct current (DC) from the battery 110 into alternating current (AC) supplied to the motors of the drive units 112.

The drive units 112 are coupled to two or more hubs 116 to which wheels may mount. Each hub 116 includes a corresponding brake 118, such as the illustrated disc brakes. The drive units 112 or other component may also provide regenerative braking. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that requires heating in preparation for use, such as diesel engines.

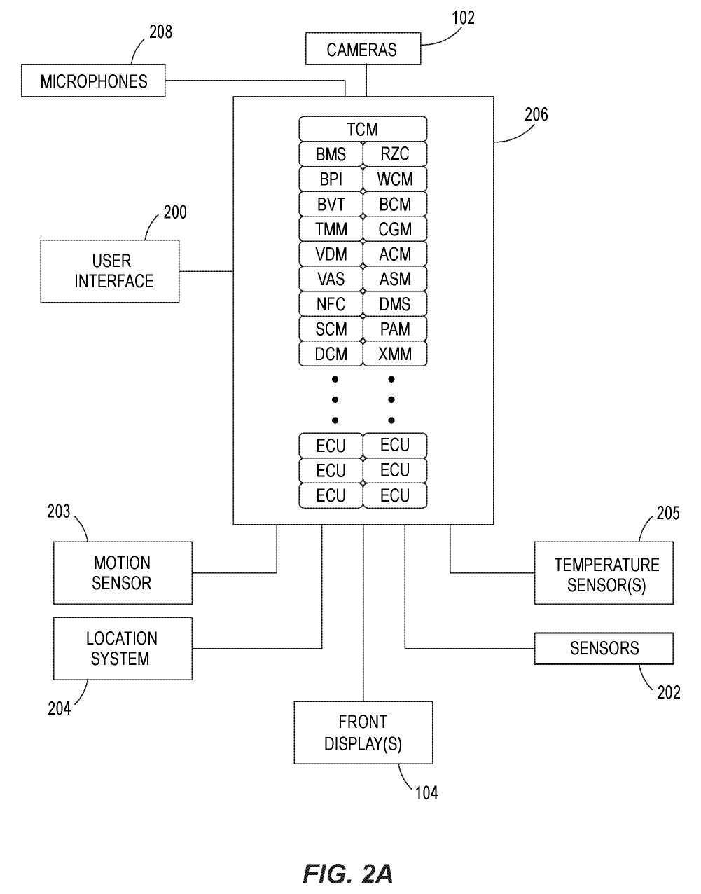

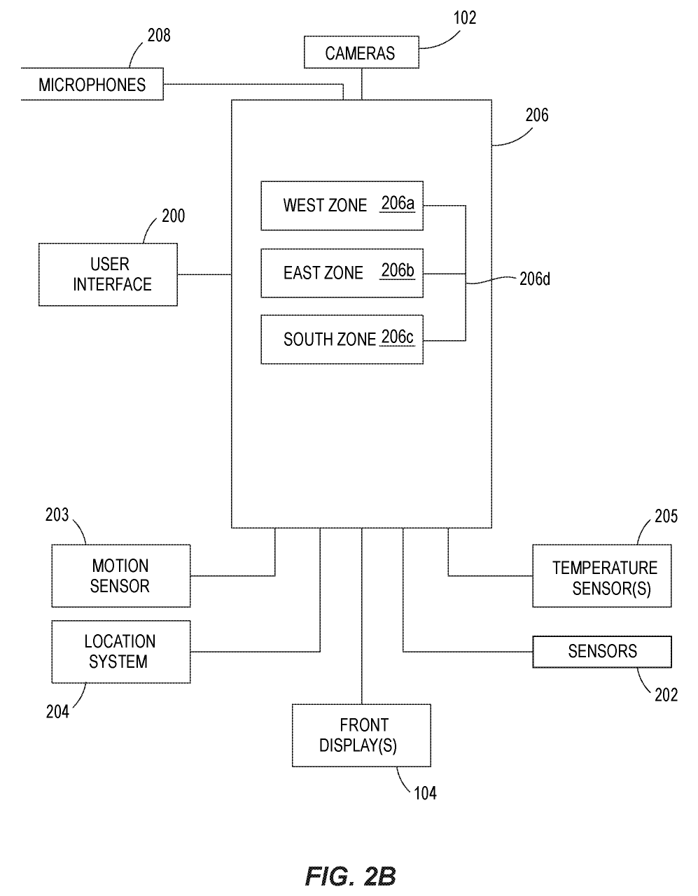

FIG. 2A illustrates example components of the vehicle 100 of FIG. 1A. As shown in FIG. 2A, the vehicle 100 includes the cameras 102, the one or more front displays 104, a user interface 200, one or more sensors 202, a motion sensor 203, and a location system 204. The one or more sensors 202 may include ultrasonic sensors, radio detection and ranging (RADAR) sensors, light detection and ranging (LIDAR) sensors, or other types of sensors. The location system 204 may be implemented as a global positioning system (GPS) receiver. The user interface 200 allows a user, such as a driver or passenger in the vehicle 100, to provide input.

The components of the vehicle 100 may include one or more temperature sensors 205. The temperature sensors 205 may include sensors configured to sense an ambient air temperature, temperature of the battery 110, temperature of power electronics 114, temperature of each drive unit 112 and/or each motor of each drive unit 112, or the temperature of any other component of the vehicle 100.

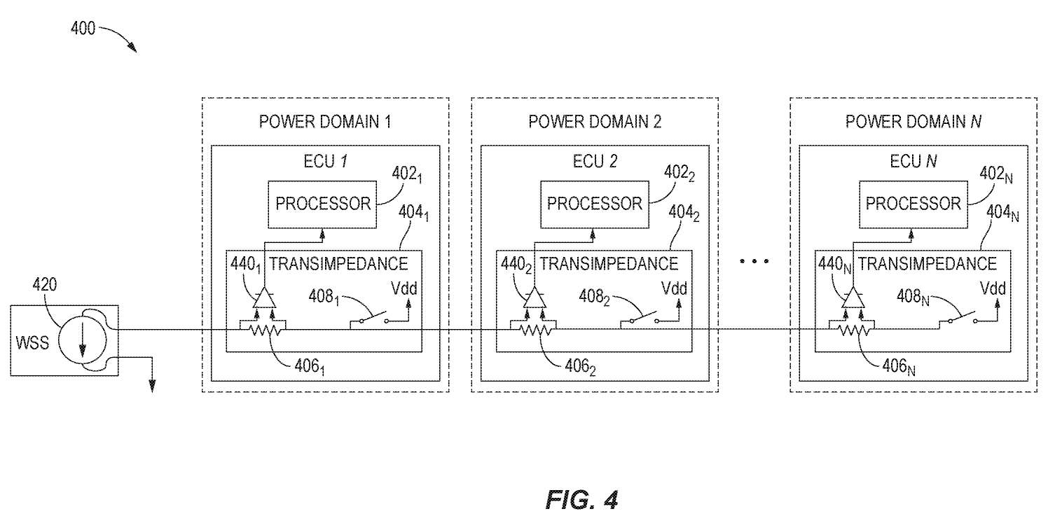

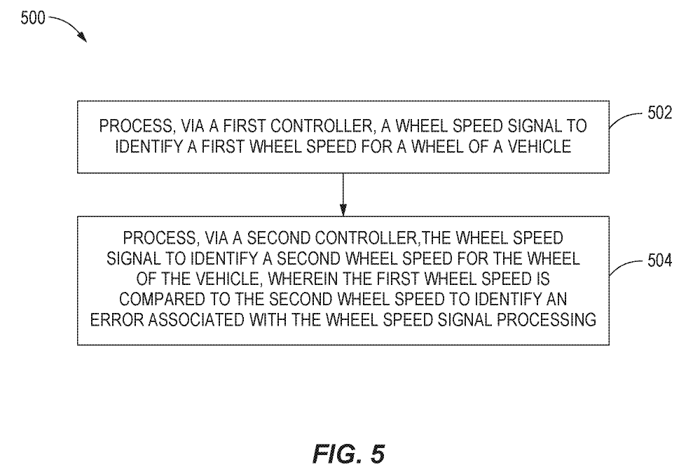

A control system 206 executes instructions to perform at least some of the actions or functions of the vehicle 100, including the functions described in relation to FIGS. 4 and 5. For example, as shown in FIG. 2, the control system 206 may include one or more electronic control units (ECUs) configured to perform at least some of the actions or functions of the vehicle 100, including the functions described herein. In certain embodiments, each of the ECUs is dedicated to a specific set of functions. Each ECU may be a computer system and each ECU may include functionality as described herein.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102 and sensors 202. The sensor signals collected by the CGM ECU are then communicated to the appropriate ECUs for performing, for example, the operations and functions described herein.

The control system 206 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU. If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 208, etc.) to the TCM ECU.

Referring to FIG. 2B, in some embodiments, the control system 206 may be implemented as a plurality of zonal controllers 206a, 206b, 206c. Each zonal controller 206a, 206b, 206c may control a subset of systems of the vehicle. The subset of systems controlled by each zonal controller 206a, 206b, 206c may be generally assigned based on location within the vehicle 100. For example, a west zonal controller 206a may control systems on a driver side of the vehicle 100, an east zonal controller 206b may control systems on a passenger side of the vehicle 100, and a south zonal controller 206c may control systems in a rear portion of the vehicle. Each zonal controller 206a, 206b, 206c may implement a portion of the functions ascribed to the ECUs of the control system 206 of FIG. 2A. The functions of the ECUs may be distributed among the zonal controller 206a, 206b, 206c such that only one zonal controller 206a, 206b, 206c implements the functions of each ECU. Alternatively, the functions of an ECU may be duplicated across multiple zonal controllers 206a, 206b, 206c, each zonal performing the functions of the ECU for the portion of the vehicle to which that zonal controller 206a, 206b, 206c is assigned. The zonal controllers 206a, 206b, 206c may be connected to one another by a network 206d, such as an Ethernet network, controller area network (CAN), or other type of network.

Certain aspects of the present disclosure are directed towards techniques for wheel speed sensing. In some aspects, a speed sensor may be implemented for each wheel of the vehicle. That is, four wheel sensors, one for each wheel of a vehicle, may be implemented. In some cases, errors may arise during the processing of wheel sensor signals causing safety issues for the vehicle. Some aspects of the present disclosure are directed toward the redundant processing of wheel sensor signals. For example, a sense signal from a wheel sensor may be provided to at least two ECUs for processing. The sense signal may be processed by the ECUs independently to derive a wheel speed. The derived wheel speeds from the ECUs may be compared to identify one or more errors, such as a processing error concerning the derivation of the wheel speed. For example, suppose a difference between the derived wheel speeds from two or more ECUs is greater than a predetermined threshold. In that case, an error flag may be set to indicate an error, in response to which one or more safety measures may be performed, such as bringing the vehicle to a safe stop or notifying a driver of the vehicle.

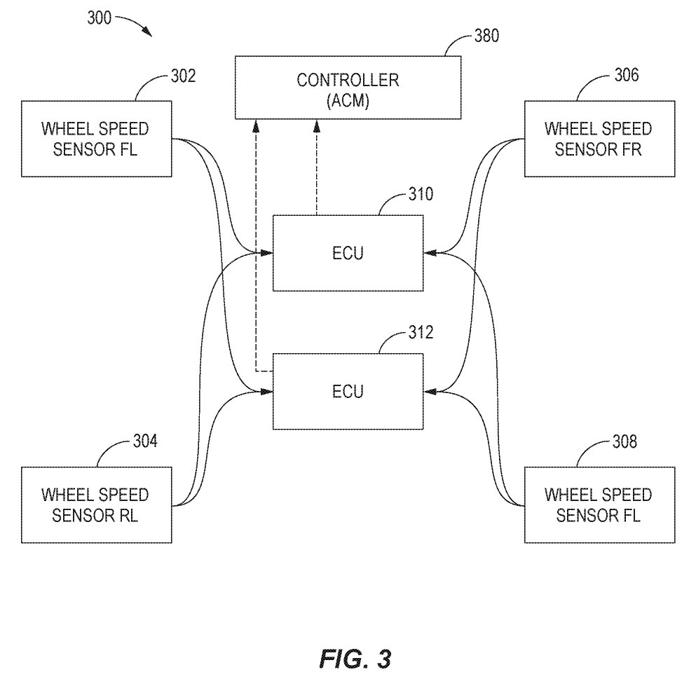

FIG. 3 illustrates a processing system with multiple ECUs where each of the multiple wheel sensor signals is consumed by the multiple ECUs, in accordance with certain aspects of the present disclosure. As shown, there may be four sensors such as a wheel speed sensor 302 for a front-left (FL) wheel, a wheel speed sensor 304 for a rear-left (RL) wheel, a wheel speed sensor 306 for a front-right (FR) wheel, and a wheel speed sensor 308 for a rear-right (RR) wheel. Each of the sensor signals may be provided to at least two ECUs, such as ECUs 310, 312. For instance, the ECU 310 may receive wheel sensor signals from respective sensors 302, 304, and in some aspects, also receive wheel sensor signals from respective sensors 306, 308. Similarly, the ECU 312 may receive wheel sensor signals from respective sensors 302, 304, and in some aspects, also receive wheel sensor signals from respective sensors 306, 308. The ECUs 310, 312 may process each wheel sensor signal to derive a wheel speed.

In some aspects, the wheel sensor signal may include a current that is serially provided to the ECUs. A sense resistor of each ECU may be used to measure the current, which indicates the wheel speed.

FIG. 4 illustrates an example current sensing system 400 for identifying wheel speed at each of multiple ECUs, in accordance with certain aspects of the present disclosure. As shown, the current sensing system 400 may include ECUs 1 to N, N being an integer greater than 1. As shown, each ECU 1-N may include a respective processor 402₁ to 402_{N} (collectively referred to herein as “processors 402”) as well as a respective transconductance interface 404₁ to 404_{N} (collectively referred to herein as “interfaces 404) for current detection (e.g., interface 404 of ECU 1). For example, a wheel speed sensor (labeled “WSS”) may include a current source 420 sinking a current from the interfaces 404 of the ECUs. Each of the interfaces 404 includes a respective sense resistor 406₁ to 406_{N} (collectively referred to as “sense resistors 406”). The current generated via the current source 420 flows across the sense resistors 406 of the interfaces 404. That is, the sense resistors 406 may be part of a series path across the ECUs as shown, where the current flows on the series path for wheel speed sensing by the ECUs.

Each of the interfaces 404 includes a respective sense amplifier 440₁ to 440_{N} (collectively referred to as “amplifiers 440”). Each of the sense amplifiers 440 senses a voltage across an associated sense resistor that indicates the current generated via the current source 420. The sensed voltage indicates the wheel speed. The sensed voltage may be provided to a respective one of the processors 402 to indicate the wheel speed. While one example of a transconductance interface is described to facilitate understanding, any suitable implementation of a transconductance interface may be used.

In some aspects, each of the interfaces 404 may include a respective switch 408₁ to 408_{N} (collectively referred to herein as “switches 408”) between the current source 420 and a voltage supply rail (Vdd). The switches 408 may be controlled to disable one or more of the ECUs. For instance, the switch 408₂ of the interface 404₂ may be closed to disable ECU N. As another example, the switch 408₁ of interface 404₁ may be closed to disable ECU 2 to ECU N.

In some cases, ECUs consume sensor signals with equal latency and without inter-ECU networking or power dependency. For example, each of the ECUs may be part of an associated power domain such as power domains 1-N. Each power domain may consume power from an independent power source so that power supply-related errors do not impact multiple ECUs. In other words, even if one power domain experiences an issue that causes one ECU to stop functioning, other ECUs can continue to power the WSS (e.g., current source 420), allowing wheel speed monitoring to continue. For instance, if the power domain N experiences an error, the switch 408_{N} may be opened, disabling ECU N while ECU 1 and ECU 2 continue to monitor wheel speed.

While FIG. 4 illustrates an example technique for wheel speed sensing using current sensing to facilitate understanding, certain aspects of the present disclosure may be implemented using any suitable wheel sensing technique. In some aspects, a pulse-width modulated (PWM) signal may be provided via the wheel sensor to each ECU, where the ECU detects the duty cycle of the PWM signal and indicates the wheel speed. In some cases, a single edge nibble transmission (SENT) protocol may be used to communicate the sensed wheel speed to each ECU.

Referring back to FIG. 3, in some aspects, the ECU 310 may be a break box for a vehicle, and the ECU 312 may be a west zone controller, such as the west zone controller 206a described with respect to FIG. 2B. In some embodiments, the ECU 312 may be a first-party ECU (e.g., a vehicle manufacturer ECU), and ECU 310 may be a third-party ECU (e.g., a vehicle supplier ECU). In some aspects, the processing system 300 of FIG. 3 may include a controller 380. In some implementations, the controller 380 may correspond to the Autonomy Control Module (ACM) ECU described with respect to FIG. 2A. The detected wheel speed from the ECUs 310, 312 may be provided to the controller 280. The controller 380 may compare the detected wheel speeds and identify whether a difference between the wheel speeds is greater than a threshold. If so, the controller 380 may output an error flag, as described herein.

FIG. 5 is a flow diagram illustrating example operations 500 for wheel speed signal processing, in accordance with certain aspects of the present disclosure. The operations 500 may be performed, for example, by a processing system such as the processing system 300 of FIG. 3.

At block 502, the processing system may process, via a first controller (e.g., ECU 310 of FIG. 3 or ECU 1 of FIG. 4), a wheel speed signal to identify a first wheel speed for a wheel of a vehicle. A wheel speed sensor (e.g., wheel speed sensor 302 of FIG. 3 or current source 420 of FIG. 4) may generate the wheel speed signal for the wheel of the vehicle.

At block 504, the processing system may process, via a second controller (e.g., ECU 312 of FIG. 3 or ECU 2 of FIG. 4), the wheel speed signal to identify a second wheel speed for the wheel of the vehicle. The first wheel speed may be compared to the second wheel speed to identify an error associated with the wheel speed signal processing. For example, the processing system may compare, via a third controller (e.g., controller 380 of FIG. 3), the first wheel speed and the second wheel speed to identify the error.

In some aspects, the first controller may include at least one first sense resistor (e.g., sense resistor 406₁ of FIG. 4). The second controller may include at least one second sense resistor (e.g., sense resistor 406₂ of FIG. 4). The at least one first sense resistor and the at least one second sense resistor may be part of a series path and the wheel speed signal may include a current provided on the series path. In some aspects, processing the wheel speed signal via the first controller may involve sensing, via the first controller (e.g., via amplifier 440₁ of FIG. 4), a voltage across the at least one first sense resistor to identify the first wheel speed. Processing the wheel speed signal via the second controller may involve sensing, via the second controller (e.g., via amplifier 440₂ of FIG. 4) a voltage across the at least one second sense resistor to identify the second wheel speed. The first controller and the second controller may be part of different power domains (e.g., consume power from separate power sources).

In some aspects, the wheel speed signal is provided to the first controller with a first latency and the wheel speed signal is provided to the second controller with a second latency. A difference between the first latency and the second latency may be less than a predetermined latency difference threshold.

In some aspects, the processing system may generate, via another wheel speed sensor (e.g., wheel speed sensor 304), another wheel speed signal for another wheel of the vehicle. The processing system may process, via the first controller, the other wheel speed signal to identify a third wheel speed for the other wheel of the vehicle and process, via the second controller, the other wheel speed signal to identify a fourth wheel speed for the other wheel of the vehicle. The processing system may compare the third wheel speed with the fourth wheel speed to identify another error associated with the wheel speed signal processing for the other wheel speed sensor.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

1. An apparatus for wheel speed signal processing, comprising:
a first controller configured to receive a wheel speed signal and process the wheel speed signal to identify a first wheel speed for a wheel of a vehicle; and
a second controller configured to receive the wheel speed signal and process the wheel speed signal to identify a second wheel speed for the wheel of the vehicle, wherein the first wheel speed is compared to the second wheel speed to identify an error associated with the wheel speed signal processing.

2. The apparatus of claim 1, further comprising a wheel speed sensor configured to generate the wheel speed signal for the wheel of the vehicle.

3. The apparatus of claim 1, further comprising a third controller configured to compare the first wheel speed and the second wheel speed to identify the error.

4. The apparatus of claim 1, wherein:
the first controller comprises at least one first sense resistor;
the second controller comprises at least one second sense resistor, wherein the at least one first sense resistor and the at least one second sense resistor are part of a series path; and
the wheel speed signal comprises a current provided on the series path.

5. The apparatus of claim 4, wherein:
the first controller is configured to sense a voltage across the at least one first sense resistor to identify the first wheel speed; and
the second controller is configured to sense a voltage across the at least one second sense resistor to identify the second wheel speed.

6. The apparatus of claim 1, wherein the first controller and the second controller are part of different power domains.

7. The apparatus of claim 1, wherein:
the wheel speed signal is provided to the first controller with a first latency; and
the wheel speed signal is provided to the second controller with a second latency, a difference between the first latency and the second latency being less than a predetermined latency difference threshold.

8. The apparatus of claim 1, wherein:
the first controller is further configured to receive another wheel speed signal and process the other wheel speed signal to identify a third wheel speed for another wheel of the vehicle; and
the second controller is further configured to receive the other wheel speed signal and process the other wheel speed signal to identify a fourth wheel speed for the other wheel of the vehicle.

9. The apparatus of claim 8, wherein the third wheel speed is compared with the fourth wheel speed to identify another error associated with the wheel speed signal processing for the other wheel speed sensor.

10. A method for wheel speed signal processing, comprising:
processing, via a first controller, a wheel speed signal to identify a first wheel speed for a wheel of a vehicle; and
processing, via a second controller, the wheel speed signal to identify a second wheel speed for the wheel of the vehicle, wherein the first wheel speed is compared to the second wheel speed to identify an error associated with the wheel speed signal processing.

11. The method of claim 10, further comprising generating, via a wheel speed sensor, the wheel speed signal for the wheel of the vehicle.

12. The method of claim 10, further comprising comparing, via a third controller, the first wheel speed and the second wheel speed to identify the error.

13. The method of claim 10, wherein:
the first controller comprises at least one first sense resistor;
the second controller comprises at least one second sense resistor;
the at least one first sense resistor and the at least one second sense resistor are part of a series path; and
the wheel speed signal comprises a current provided on the series path.

14. The method of claim 13, wherein:
processing the wheel speed signal via the first controller comprises sensing, via the first controller, a voltage across the at least one first sense resistor to identify the first wheel speed; and
processing the wheel speed signal via the second controller comprises sensing, via the second controller, a voltage across the at least one second sense resistor to identify the second wheel speed.

15. The method of claim 10, wherein the first controller and the second controller are part of different power domains.

16. The method of claim 10, wherein:
the wheel speed signal is provided to the first controller with a first latency; and
the wheel speed signal is provided to the second controller with a second latency, a difference between the first latency and the second latency being less than a predetermined latency difference threshold.

17. The method of claim 10, further comprising:
generating, via another wheel speed sensor, another wheel speed signal for another wheel of the vehicle;
processing, via the first controller, the other wheel speed signal to identify a third wheel speed for the other wheel of the vehicle; and
processing, via the second controller, the other wheel speed signal to identify a fourth wheel speed for the other wheel of the vehicle.

18. The method of claim 17, further comprising comparing the third wheel speed with the fourth wheel speed to identify another error associated with the wheel speed signal processing for the other wheel speed sensor.

19. A vehicle, comprising:
a wheel;
a wheel speed sensor configured to generate a wheel speed signal for the wheel;
a first controller configured to receive the wheel speed signal and process the wheel speed signal to identify a first wheel speed for the wheel; and
a second controller configured to receive the wheel speed signal and process the wheel speed signal to identify a second wheel speed for the wheel of the vehicle, wherein the first wheel speed is compared to the second wheel speed to identify an error associated with processing the wheel speed signal.

20. The vehicle of claim 1, further comprising a third controller configured to compare the first wheel speed and the second wheel speed to identify the error.
